(19) United States
(12) Patent Application Publication
(10) Pub. No.: US 2006/0063877 A1
(43) Pub. Date: Mar. 23, 2006

(54) Aqueous dispersions containing ethylene copolymer waxes

(75) Inventors: Wolfgang Gaschler, Heidelberg (DE); Andreas Fechtenkotter, Ludwigshafen (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 10/542,715

(22) PCT Filed: Jan. 15, 2004
(86) PCT No.: PCT/EP04/00240

§ 371 Date: Jul. 20, 2005

(30) Foreign Application Priority Data
Jan. 27, 2003 (DE) 103 03 170.7

(51) Int. Cl. C08L 91/08

(52) U.S. Cl. 524/487; 524/556

(57) ABSTRACT

Aqueous dispersions comprising at least one ethylene copolymer wax comprising from 60 to 99.5% by weight of ethylene and from 0.5 to 40% by weight of at least one ethylenically unsaturated carboxylic acid in copolymerized form and also at least one hydrophobic low molecular weight organic substance.

The present invention relates to aqueous dispersions comprising at least one ethylene copolymer wax comprising from 60 to 99.5% by weight of ethylene and from 0.5 to 40% by weight of at least one ethylenically unsaturated carboxylic acid in copolymerized form and also at least one hydrophobic low molecular weight organic substance.

The preparation of aqueous dispersions of intrinsically hydrophobic substances is of great industrial importance. Emulsifiers are generally used as auxiliaries for preparing and stabilizing the dispersion. However, for numerous applications, for example in paper coating, it would be desirable to dispense with the use of emulsifiers.

EP-A 0 691 390, Progress in Organic Coatings 1995, 26, 207, and Progress in Organic Coatings 1996, 29, 201, disclose aqueous dispersions of fluorescent dyes which are obtainable by free-radical polymerization of, for example, acrylic acid, methyl methacrylate, n-butyl acrylate and styrene in an organic solvent, for example isobutanol, in the presence of a fluorescent dye. The copolymers obtainable in this way have a weight average molecular weight M_{w} of from 20 000 to 500 000 g/mol. The solvent can be removed later, i.e. before or after the actual application of the dispersion. However, the use of solvents is generally disadvantageous.

EP-A 0 691 384 discloses aqueous dispersions of dyes prepared using two copolymers which are likewise prepared by solution polymerization. The solvent can be removed later, i.e. before or after the actual application of the dispersion. What has been said above applies to the use of solvents.

Fluorescent dyes are used, for example, to give articles such as plastics or fibers improved whiteness. It is generally desirable to use fluorescent dyes which have a high quantum yield. Oil-soluble fluorescent dyes are generally superior to polar and thus water-soluble fluorescent dyes. However, it is difficult to use oil-soluble fluorescent dyes in processes which take place in an aqueous medium. It has hitherto not been possible to use oil-soluble fluorescent dyes successfully in paper manufacture, especially in paper coating.

It is an object of the present invention to provide aqueous dispersions of hydrophobic substances which are simple to prepare and contain a very small quantity, if any, of additional emulsifiers. A further object of the invention is to provide a simple process for preparing aqueous dispersions of hydrophobic substances. Another object of the invention is to provide new uses of aqueous dispersions.

We have found that these objects are achieved by the aqueous dispersions defined at the outset.

The dispersions of the present invention comprise at least one ethylene copolymer wax. The ethylene copolymer wax(es) in question is/are at least one ethylene copolymer wax comprising from 60 to 99.9% by weight, preferably from 65 to 85% by weight, of ethylene and from 0.1 to 40% by weight, preferably from 15 to 35% by weight, of at least one ethylenically unsaturated carboxylic acid in copolymerized form.

The dispersions of the present invention further comprise at least one hydrophobic low molecular weight organic substance. For the purposes of the present invention, hydrophobic substances are organic substances which have a solubility of less than 0.5 g/l in water at room temperature. For the present purposes, low molecular weight substances are substances having a molecular weight of up to 2000 g/mol, with polymer waxes being excluded. In the case of low molecular weight substances which have a molecular weight distribution, the molecular weight is taken to be the number average Mₙ.

Preferred low molecular weight substances are selected from among oil-soluble dyes, in particular oil-soluble fluorescent dyes, also known as optical brighteners, biocides, fragrances and flavors. Preference is given to at least one low molecular weight hydrophobic substance present in the dispersions of the present invention being an oil-soluble dye.

In particular, the low molecular weight hydrophobic substance is an oil-soluble dye. Preferred oil-soluble dyes are those of the class of optical brighteners, in particular substituted or unsubstituted distyrylbiphenyls and distyrylbenzenes. Particular preference is given to
distyryl compounds of the formula II a 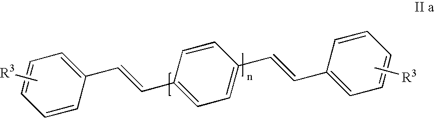
benzoxazole derivatives of the formula II b 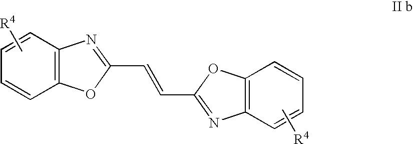
   where
R³, R⁴ are identical or different and are selected independently from among hydrogen, cyano, methyl and ethyl; preference is given to the two radicals R being identical and the two radicals are particularly preferably each cyano or methyl;
n is an integer in the range from 1 to 5, in particular 1 or 2.

A very particularly preferred example of an oil-soluble dye of the formula II b is the compound of the formula II b.1

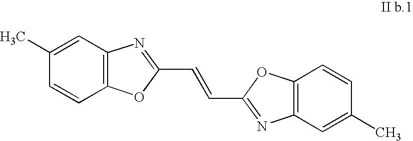

The dispersions of the present invention contain from 0.001 to 10% by weight, preferably up to 5% by weight and particularly preferably up to 1% by weight, of one or more of the above-described organic low molecular weight hydrophobic substances.

Ethylene copolymer waxes comprising ethylene and ethylenically unsaturated carboxylic acids can advantageously be prepared by free-radical-initiated copolymerization under high-pressure conditions, for example in stirred high-pressure autoclaves or in high-pressure tube reactors. Preparation of the copolymer waxes in stirred high-pressure autoclaves is preferred. Stirred high-pressure autoclaves are known per se and a description may be found in Ullmann's Encyclopedia of Industrial Chemistry, 5^{th} edition, keywords: waxes, Vol. A 28, p. 146 ff., Verlag Chemie Weinheim, Basel, Cambridge, New York, Tokyo, 1996. They usually have a length/diameter ratio in the range from 5:1 to 30:1, preferably from 10:1 to 20:1. The high-pressure tube reactors which can also be employed are likewise described in Ullmann's Encyclopedia of Industrial Chemistry, 5^{th} edition, keywords: waxes, Vol. A 28, p. 146 ff., Verlag Chemie Weinheim, Basel, Cambridge, New York, Tokyo, 1996.

Suitable pressure conditions for the polymerization are from 500 to 4000 bar, preferably from 1500 to 2500 bar. The reaction temperatures are in the range from 170 to 300° C., preferably in the range from 200 to 280° C.

The polymerization can be carried out in the presence of one or more regulators. Regulators used are, for example, hydrogen or an aliphatic aldehyde or an aliphatic ketone of the formula III 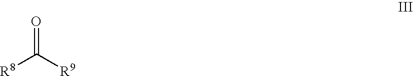
or mixtures thereof.

In this formula, the radicals R⁸ and R⁹ are identical or different and are selected from among
hydrogen;
C₁-C₆-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl such as methyl, ethyl, n-propyl, isopropyl, n-butyl, isobutyl, sec-butyl and tert-butyl;
C₃-C₁₂-cycloalkyl such as cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl.

In a particular embodiment, the radicals R³ and R⁹ are covalently joined to one another to form a 4- to 13-membered ring. Thus, R⁸ and R⁹ can together be, for example:
—(CH₂)₄—, —(CH₂)₅—, —(CH₂)₆, —(CH₂)₇,
—CH(CH₃)—CH₂—CH₂—CH(CH₃)— or
—CH(CH₃)—CH₂—CH₂—CH₂—CH(CH₃)—.

Well-suited regulators are alkylaromatic compounds, for example toluene, ethylbenzene or one or more isomers of xylene. The use of aldehydes and ketones of the formula III as regulators is preferably dispensed with. Preference is given to introducing no further regulators apart from the stabilizers which can be added to make organic peroxides easier to handle and can likewise have the function of a molecular weight regulator.

As initiators for the free-radical polymerization, it is possible to use the customary free-radical initiators such as organic peroxides, oxygen or azo compounds. Mixtures of a plurality of free-radical initiators are also useful.

Suitable peroxides selected from among commercially available substances are
didecanoyl peroxide, 2,5-dimethyl-2,5-di(2-ethylhexanoylperoxy)hexane, tert-amyl peroxy-2-ethylhexanoate, dibenzoylperoxide, tert-butyl peroxy-2-ethylhexanoate, tert-butyl peroxydiethylacetate, tert-butyl peroxydiethylisobutyrate, 1,4-di(tert-butylperoxycarbo)cyclohexane as an isomer mixture, tert-butyl perisononanoate, 1,1-di(tert-butylperoxy)-3,3,5-trimethylcyclohexane, 1,1-di(tert-butylperoxy)cyclohexane, methyl isobutyl ketone peroxide, tert-butyl peroxyisopropylcarbonate, 2,2-di(tert-butylperoxy)butane or tert-butyl peroxyacetate;
tert-butyl peroxybenzoate, di-tert-amyl peroxide, dicumyl peroxide, the isomeric di(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butyl peroxide, 1,3-diisopropylbenzene monohydroperoxide, cumene hydroperoxide or tert-butyl hydroperoxide; or dimeric or trimeric ketone peroxides of the formulae IV a to IV c.

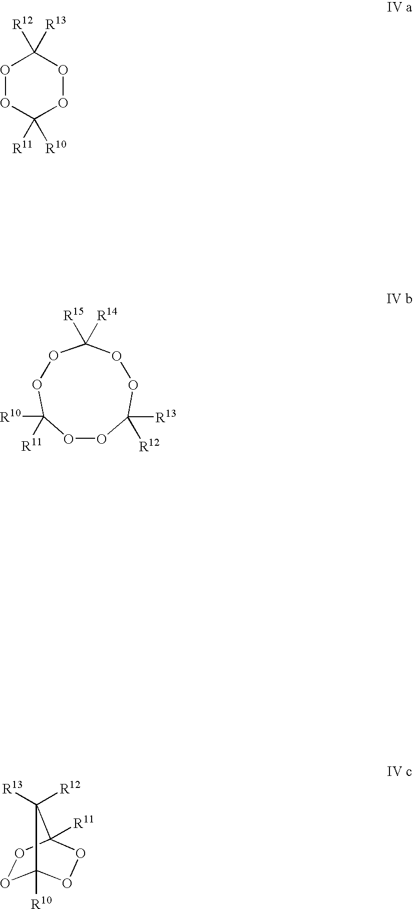

In these formulae, the radicals R¹⁰ to R¹⁵ are identical or different and are selected from among
—C₁-C₈-alkyl such as methyl, ethyl, n-propyl, isopropyl, n-butyl, sec-butyl, isobutyl, tert-butyl, n-pentyl, sec-pentyl, isopentyl, n-hexyl, n-heptyl, n-octyl; preferably linear C₁-C₆-alkyl such as methyl, ethyl, n-propyl, n-butyl, n-pentyl, n-hexyl, particularly preferably linear C₁-C₄-alkyl such as methyl, ethyl, n-propyl and n-butyl, very particularly preferably ethyl;
C₆-C₁₄-aryl such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl.

Peroxides of the formulae IV a to IV c and methods of preparing them are known from EP-A 0 813 550.

Particularly useful peroxides are di-tert-butyl peroxide, tert-butyl peroxypivalate, tert-butyl peroxyisononanoate and dibenzoyl peroxide and mixtures thereof. An azo compound which may be mentioned by way of example is azobisisobutyronitrile (“AIBN”). Free-radical initiators are introduced in amounts customary for polymerizations.

Numerous commercially available organic peroxides are admixed with stabilizers before they are sold in order to make them easier to handle. Suitable stabilizers are, for example, white oil and hydrocarbons such as, in particular, isododecane. Under the conditions of the free-radical high-pressure polymerization, such stabilizers can act as molecular weight regulators. For the purposes of the present invention, reference to the use of molecular weight regulators means the additional use of further molecular weight regulators other than the stabilizers.

Monomers used are ethylene together with at least one ethylenically unsaturated carboxylic acid. Preference is given to at least one ethylenically unsaturated carboxylic acid being a carboxylic acid of the formula I

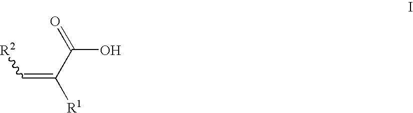

In the formula I, the radicals are defined as follows:
R¹ is selected from among hydrogen and
   C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl; particularly preferably C₁-C₄-alkyl such as methyl, ethyl, n-propyl, isopropyl, n-butyl, isobutyl, sec-butyl and tert-butyl;
R² is selected from among hydrogen and
   C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl, n-decyl; particularly preferably C₁-C₄-alkyl such as methyl, ethyl, n-propyl, isopropyl, n-butyl, isobutyl, sec-butyl and tert-butyl;
   COOH, COOCH₃, COOC₂H₅.

Very particular preference is given to R¹ being hydrogen or methyl and R² being hydrogen.

The ratio in which the monomers are metered in usually does not correspond precisely to the ratio of the units in the ethylene copolymer waxes used according to the present invention because ethylenically unsaturated carboxylic acids are generally incorporated more easily into ethylene copolymer waxes than is ethylene.

The monomers are usually metered in jointly or separately.

The monomers can be compressed to the polymerization pressure in a compressor. In another embodiment of the process of the present invention, the monomers are firstly brought to an elevated pressure of, for example, from 150 to 400 bar, preferably from 200 to 300 bar and in particular 250 bar, by means of a pump and then to the actual polymerization pressure by means of a compressor.

The polymerization can, as a matter of choice, be carried out in the absence or presence of solvents, with mineral oils, white oil and other solvents which are present in the reactor during the polymerization and have been used for stabilizing the free-radical initiator(s) not being regarded as solvents for the purposes of the present invention.

In one embodiment, the polymerization is carried out in the absence of solvents.

The dispersions of the present invention preferably contain from 0.05 to 40% by weight, more preferably from 10 to 35% by weight, of one or more ethylene copolymer waxes. It is advantageous for the proportion by weight of the ethylene copolymer wax or waxes in the dispersions of the present invention to be not less than that of the hydrophobic low molecular weight organic substance or substances. The proportion by weight of the ethylene copolymer wax or waxes in the dispersions of the present invention is advantageously more than twice the proportion by weight of the hydrophobic low molecular weight organic substance or substances, particularly advantageously more than ten times the proportion by weight of the latter. If the hydrophobic low molecular weight organic substance or substances is/are an oil-soluble fluorescent dye/oil-soluble fluorescent dyes, the proportion by weight of the ethylene copolymer wax or waxes in the dispersions of the present invention is more than one hundred times the proportion by weight of the hydrophobic low molecular weight organic substance or substances, particularly advantageously more than two hundred times the proportion by weight of the latter.

The dispersions of the present invention usually further comprise one or more basic substances, for example hydroxides and/or carbonates and/or hydrogencarbonates of alkali metals, ammonia, organic amines such as triethylamine, diethylamine, ethylamine, trimethylamine, dimethylamine, methylamine, ethanolamine, diethanolamine, triethanolamine, methyldiethanolamine, n-butyldiethanolamine, N,N-dimethylethanolamine. The dispersions of the present invention preferably contain an amount of basic substance or substances which is such that at least half, preferably at least three quarters, of the carboxyl groups of the ethylene copolymer wax or waxes are neutralized.

In one embodiment of the present invention, the dispersions of the present invention contain an amount of basic substance or substances which is such that the carboxyl groups of the ethylene copolymer wax or waxes are quantitatively neutralized.

The dispersions of the present invention usually have a basic pH, preferably a pH of from 7.5 to 14, particularly preferably 8 or above and very particularly preferably 8.5 or above.

The dispersions of the present invention preferably do not contain any emulsifiers or protective colloids. The dispersions of the present invention are stable even without such surface active auxiliaries, i.e. at a shear rate of 100 cm⁻¹, the light transmittance alters by no more than 2%, measured on a dispersion having a solids content of 0.1% by weight and using pure water as reference. Owing to their good use properties, the dispersions of the present invention have numerous applications.

The present invention further provides a process for preparing the aqueous dispersions of the present invention. In the process of the present invention, one or more ethylene copolymer waxes is/are firstly mixed with at least one hydrophobic low molecular weight organic substance and the mixture is subsequently dispersed in water.

The procedure for carrying out the process of the present invention starts out from one or more of the above-described ethylene copolymer waxes. This is placed in a vessel, for example a flask, an autoclave or a batch reactor. In one variant, one or more hydrophobic low molecular weight organic substances are added and the ethylene copolymer wax or waxes is heated to a temperature above its melting point. It is advantageously heated to a temperature which is at least 10° C., particularly advantageously at least 30° C., above the melting point of the ethylene copolymer wax or waxes.

If a plurality of different ethylene copolymer waxes are used, the mixture is heated to a temperature which is above the melting point of the ethylene copolymer wax having the highest melting point. When a plurality of different ethylene copolymer waxes are used, the mixture is advantageously heated to a temperature which is at least 10° C. above the melting point of the ethylene copolymer wax having the highest melting point. When a plurality of different ethylene copolymer waxes are used, the mixture is particularly advantageously heated to a temperature which is at least 30° C. above the melting point of the ethylene copolymer wax having the highest melting point.

Dispersion of the hydrophobic low molecular weight organic substance or substances can be aided by further measures, for example by mechanical or pneumatic stirring or by shaking.

In one variant of the process of the present invention, the ethylene copolymer wax or waxes is firstly heated and the hydrophobic low molecular weight organic substance or substances is/are added to the molten ethylene copolymer wax or waxes. It is also possible for the hydrophobic low molecular weight organic substance or substances to be added a little at a time during the heating procedure.

Water and one or more basic substances and, if desired, further constituents such as ethylene glycol are subsequently added. The order of the addition of water and the addition of the basic substance or substances and further constituents is immaterial. If the temperature is above 100° C., it is advantageous to work under superatmospheric pressure and to choose the vessel correspondingly. The emulsion formed is homogenized, for example by mechanical or pneumatic stirring or by shaking. The aqueous dispersion prepared in this way can subsequently be cooled.

The present invention further provides for the use of the aqueous dispersions of the present invention in paper coating.

The present invention further provides paper coating compositions comprising the dispersions according to the present invention and provides a process for preparing the paper coating compositions of the present invention using the dispersions of the present invention.

The paper coating compositions of the present invention further comprise customarily used pigments, in particular white pigments, for example barium sulfate, calcium carbonate, calcium sulfoaluminate, kaolin, talc, titanium dioxide, chalk or coating clay. Pulverulent plastics, for example polystyrene, are also suitable.

The paper coating compositions of the present invention comprise at least one pigment. The other constituents of the paper coating compositions of the present invention are typically standardized on the basis of the proportion of pigment.

In one embodiment of the present invention, the paper coating compositions of the present invention comprise one or more dispersions according to the present invention in a proportion of from 0.5 to 95% by weight, based on the pigment or pigments; preference is given to from 1 to 50% by weight.

The paper coating compositions of the present invention can further comprise additional dispersants which can serve to disperse the pigment or pigments. Suitable dispersants are, for example, aqueous polymer solutions. Examples of aqueous polymer solutions include: aqueous solutions of polyalkali metal salts of poly(meth)acrylic acid, copolymers of (meth)acrylic acid and C₁-C₁₀-alkyl (meth)acrylates, with the copolymers being able to be fully or partially neutralized by basic alkali metal salts.

The concentrations of the aqueous polymer solutions are usually in the range from 10 to 50% by weight. If the use of dispersants is desired, amounts of, for example, from 0.01 to 5% by weight, based on the pigment or pigments, are useful.

The paper coating compositions of the present invention can further comprise one or more binders. Suitable binders are, for example, aqueous polymer dispersions of polymers or copolymers of one or more of the following monomers: butadiene, styrene, acrylonitrile, vinyl acetate, C₁-C₁₀-alkyl (meth)acrylates, hydroxy-C₁-C₁₀-alkyl (meth)acrylates, acrylamide and N-methylolacrylamide. The proportion of solids is usually in the range from 30 to 70% by weight, preferably from 40 to 60% by weight. Examples of polymer dispersions which can be added as binder to the paper coating compositions of the present invention are described in U.S. Pat. No. 3,404,116 and U.S. Pat. No. 3,990,080. If the addition of a binder is desired, typical proportions are in the range from 0.1 to 50% by weight, preferably from 2 to 20% by weight, particularly preferably from 8 to 14% by weight, of aqueous polymer dispersion, based on the pigment or pigments, as binder.

If the use of relatively large amounts of dispersions according to the present invention, for example in the range from 60 to 95% by weight based on the pigment or pigments, is desired, it is possible to add smaller proportions of binder, for example in the range from 0.1 to 14% by weight based on the pigment or pigments, or to leave out the binder or binders entirely.

The paper coating compositions of the present invention can further comprise cobinders. Examples of natural cobinders are starch, casein, gelatin, alginates and soya protein. Examples of modified natural cobinders are hydroxyethylcellulose, methylcellulose and carboxymethylcellulose and also cationically modified starch. Examples of synthetic cobinders are the customary synthetic cobinders, for example cobinders based on polyvinyl acetate or polyacrylate.

Cobinders can be present in a proportion of from 0.1 to 10% by weight, based on the pigment content.

A further constituent of the paper coating compositions of the present invention is water. The water content is usually set to from 25 to 75% by weight, based on the total mass of the paper coating composition of the present invention.

To produce a paper coating composition according to the present invention, it is possible to employ methods known per se.

The paper coating compositions of the present invention can be applied to various materials, in particular to paper. They are applied using the devices customarily employed, for example doctor blades.

The present invention further provides paper containing oil-soluble fluorescent dyes. It displays a particularly advantageous whiteness and can be produced using small amounts of fluorescent dyes having a high quantum yield. It has overall advantageous use properties. The content of oil-soluble fluorescent dyes in the paper according to the present invention is generally from 0.0001 to 5% by weight, preferably from 0.001 to 3% by weight, particularly preferably from 0.002 to 1% by weight, in each case based on paper.

A specific aspect of the present invention is paper treated with the paper coating compositions according to the present invention. Paper according to the present invention has a particularly advantageous whiteness and can be produced using small amounts of fluorescent dyes having a high quantum yield. It has overall advantageous use properties. The content of oil-soluble fluorescent dyes in the paper coated according to the present invention is, in particular, from 0.0001 to 5% by weight, preferably from 0.001 to 3% by weight, particularly preferably from 0.002 to 1% by weight.

The invention is illustrated by working examples.

### WORKING EXAMPLES

1. Preparation of Ethylene Copolymer Wax

Ethylene and methacrylic acid were copolymerized in a high-pressure autoclave as described in the literature (M. Buback et al., Chem. Ing. Tech. 1994, 66, 510). For this purpose, ethylene (12.3 kg/h) was fed into the autoclave under the reaction pressure of 1700 bar. Separately therefrom, 1.04 l/h of methacrylic acid were firstly compressed to an intermediate pressure of 250 bar and subsequently fed in under the reaction pressure of 1700 bar. Separately therefrom, 2 l/h of an initiator solution comprising tert-butyl peroxypivalate (0.13 mol·l⁻¹ in isododecane) were fed into the autoclave under the reaction pressure of 1700 bar. The reaction temperature was 220° C. This gave 3.4 kg/h of ethylene copolymer wax having the following properties: 26% by weight of methacrylic acid, 76% by weight of ethylene, melting range: 70-80° C., dynamic melt viscosity η: 68 000 mPa·s, measured at 120° C. in accordance with DIN 51562, acid number: 172 mg KOH/g (determined in accordance with DIN 53402).

The contents of ethylene and methacrylic acid in the ethylene copolymer wax were determined by NMR spectroscopy and by titration (acid number). The acid number of the ethylene copolymer wax was determined titrimetrically in accordance with DIN 53402. The KOH consumption corresponds to the methacrylic acid content of the ethylene copolymer wax.

2. Preparation of a Dispersion According to the Present Invention

200 g of ethylene copolymer wax prepared as described in Example 1 were placed in a 2 liter stirred vessel provided with an anchor stirrer and reflux condenser. 1 g of the fluorescent dye of the formula II a.1 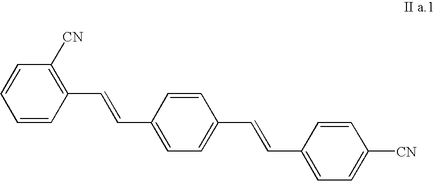
was added and the mixture was heated to 160° C. while stirring. Stirring was continued for another one hour. The fluorescent dye dissolved completely. The mixture was cooled to 140° C., a pH of 8 was set using N,N-dimethylethanolamine and the mixture was made up with water to a total volume of 1 liter. The solids content was 19.7% by weight.
3. Production and Use of Paper Coating Compositions

In a flask provided with a stirrer, the following were mixed with one another:
253 g of a dispersion according to the present invention from Example 2,
100 g of calcium carbonate (90% by weight of the particles having a diameter of less than 2 μm, commercially available as Hydrocarb 90® from Omya),
0.3 g of sodium polyacrylate, M_{w}=4000 g, fully neutralized,
0.2 ml of a 25% strength by weight aqueous solution of NaOH and
0.75 g of an aqueous dispersion of an acrylic acid-acrylic ester copolymer having the following characteristics: acrylic acid 44% by weight, ethyl acrylate 56% by weight, Brookfield viscosity at 100 s⁻¹ of a 1% strength by weight solution at a pH of 9.5: 15 mPa·s, solids content of the dispersion: 39.7% by weight. The mixture obtained in this way was adjusted to a solids content of 39.5% by weight by addition of water. This gave a paper coating composition having a pH of 9.1. The paper coating composition obtainable in this way was applied by means of a hand doctor blade to uncoated Scheufelen paper (coating weight: 12 g/m²) and dried.

The whiteness (R457) was determined as 91.5% at 457 nm by means of an Elrepho G-50-660 spectrometer in accordance with DIN 53 145 using UV light; without UV light, a value of 83.5% at 457 nm was found. This gave a difference of 8.0%.

We claim:

1. An aqueous dispersion comprising at least one ethylene copolymer wax comprising from 60 to 99.5% by weight of ethylene and from 0.5 to 40% by weight of at least one ethylenically unsaturated carboxylic acid in copolymerized form and also at least one hydrophobic low molecular weight organic substance.

2. The dispersion as claimed in claim 1, wherein at least one ethylenically unsaturated carboxylic acid is a carboxylic acid of the formula I 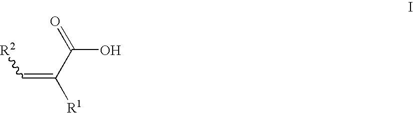
in which the radicals are defined as follows:
R¹ is selected from among hydrogen and unbranched or branched C₁-C₁₀-alkyl,
R² is selected from among hydrogen, unbranched or branched C₁-C₁₀-alkyl and COOH, COOCH₃, COOC₂H₅.

3. The dispersion as claimed in claim 1, wherein at least one low molecular weight hydrophobic substance is an oil-soluble dye.

4. The dispersion as claimed in claim 1, wherein the low molecular weight hydrophobic substance is selected from among distyryl compounds and benzoxazole derivatives.

5. A process for preparing aqueous dispersions as claimed in claim 1, which comprises firstly mixing one or more ethylene copolymer waxes with at least one hydrophobic low molecular weight organic substance and subsequently dispersing the mixture in water.

6. The use of dispersions as claimed in claim 1 in paper coating.

7. A paper coating composition comprising a dispersion as claimed in claim 1.

8. (canceled)

9. A Paper treated with a paper coating composition as claimed in claim 7.

10. The dispersion as claimed in claim 2, wherein at least one low molecular weight hydrophobic substance is an oil-soluble dye.

11. The dispersion as claimed in claim 2, wherein the low molecular weight hydrophobic substance is selected from among distyryl compounds and benzoxazole derivatives.

12. The dispersion as claimed in claim 3, wherein the low molecular weight hydrophobic substance is selected from among distyryl compounds and benzoxazole derivatives.

13. The process for preparing aqueous dispersions as claimed in claim 2, which comprises firstly mixing one or more ethylene copolymer waxes with at least one hydrophobic low molecular weight organic substance and subsequently dispersing the mixture in water.

14. The process for preparing aqueous dispersions as claimed in claim 3, which comprises firstly mixing one or more ethylene copolymer waxes with at least one hydrophobic low molecular weight organic substance and subsequently dispersing the mixture in water.

15. The process for preparing aqueous dispersions as claimed in claim 4, which comprises firstly mixing one or more ethylene copolymer waxes with at least one hydrophobic low molecular weight organic substance and subsequently dispersing the mixture in water.

16. The use of dispersions as claimed in claim 2 in paper coating.

17. The use of dispersions as claimed in claim 3 in paper coating.

18. The use of dispersions as claimed in claim 4 in paper coating.

19. The use of dispersions as claimed in claim 5 in paper coating.

20. A paper coating composition comprising a dispersion as claimed in claim 2.

21. A paper coating composition comprising a dispersion as claimed in claim 3.

22. A paper coating composition comprising a dispersion as claimed in claim 4.

23. A paper coating composition comprising a dispersion as claimed in claim 5.

24. A paper coating composition comprising a dispersion as claimed in claim 6.
